(19) United States
(12) Patent Application Publication
(10) Pub. No.: US 2017/0136438 A1
(43) Pub. Date: May 18, 2017

(54) FLUID FLOW VESSEL AND PHOTOCHEMICAL REACTOR

(71) Applicants: NATIONAL UNIVERSITY CORPORATION SHINSHU UNIVERSITY, Matsumoto-shi, Nagano (JP); SHOWA DENKO K.K., Tokyo (JP)

(72) Inventors: Hisanao USAMI, Ueda-shi, Nagano (JP); Yasushi KURODA, Toyama-shi, Toyama (JP); Mitsuhiro IMAIZUMI, Ichihara-shi, Chiba (JP)

(73) Assignees: NATIONAL UNIVERSITY CORPORATION SHINSHU UNIVERSITY, Matsumoto-shi, Nagano (JP); SHOWA DENKO K.K., Tokyo (JP)

(21) Appl. No.: 15/325,605

(22) PCT Filed: Jul. 29, 2015
(86) PCT No.: PCT/JP2015/071520

§ 371 Date: Jan. 11, 2017

(30) Foreign Application Priority Data
Aug. 4, 2014 (JP) 2014-158716

(51) Int. Cl. B01J 19/12; B01J 35/00; B01J 21/06

(52) U.S. Cl. CPC B01J 19/122; B01J 21/063; B01J 35/004; B01J 2219/0892

(57) ABSTRACT

A fluid flow-through device and a photochemical reactor. The fluid flow-through device (1) includes an outer tube (2) having an outer surface (21) and an inner surface (22); and an inner tube (3) having an outer surface (31) and an inner surface (32), the inner tube being disposed inside the outer tube and forming a channel of a fluid by the inner surface of the outer tube and the outer surface, with a distance between the inner surface of the outer tube and the outer surface of the inner tube in a thickness direction of the outer tube being from 100 nm to 5 mm. The photochemical reactor includes the fluid flow-through device and a photocatalyst disposed on at least one surface of the inner surface of the outer tube and the outer surface of the inner tube.

### TECHNICAL FIELD

The present invention relates to a fluid flow-through device which is used for continuous raw material supply, product recovery, concentration, and purification steps of a microchannel type reactor, or used for a photochemical reactor, and to a photochemical reactor for treating a fluid using a photocatalyst.

### BACKGROUND ART

An optical reactor in which a porous glass produced by heating a large number of particles formed of a glass material is provided in a glass tube, and a photocatalyst layer is formed on the surface of the porous glass and the inner surface of the glass tube is known as the prior art (for example, see PTL 1). According to this optical reactor, when light having entered from a side wall of the glass tube passes through the inside of the porous glass, the light can be extended into the interior of the optical reactor, and by activating the photocatalyst supported on the interior surface, a solution can be treated. According to this, a solution having a high concentration of dissolved matters and a solution with low light permeability, such as a suspension solution, etc., can also be treated. In addition, when plural glass tubes having a porous glass provided therein are disposed in parallel, scaling up of the optical reactor can be easily achieved. Furthermore, when plural glass tubes having a porous glass provided therein are disposed in series, treatment capability of the optical reactor can be easily enhanced. In addition, by using a quartz glass as the glass material, a wavelength band of light which is utilized in the optical reactor can be made broad.

In addition, a channel structure including a channel substrate having a channel groove and a cover substrate that covers the channel groove is known as the prior art (for example, see PTL 2). Fine particles of a photocatalyst are disposed on the wall surface of the channel of this channel structure. According to this, blocking of the channel can be inhibited. Furthermore, a microreactor including a substrate provided with a groove for forming a reaction channel and a top plate that covers an opening of the groove is known as the prior art (for example, see PTL 3). A catalyst layer is formed within the reaction channel. According to this, a catalytic reaction can be advanced against a solution that flows through within the reaction channel.

### CITATION LIST

### Patent Literature

PTL 1: WO 2012/017637 A

PTL 2: JP 2009-136819 A

PTL 3: JP 2008-194593 A

### SUMMARY OF INVENTION

### Technical Problem

However, according to the optical reactor described in PTL 1, when the porous glass is produced by heating a large number of particles formed of a glass material, the manufacturing costs become high. In addition, in maintenance of the optical reactor, when a blocked portion of the porous glass is removed, the blocked portion of the porous glass must be removed only chemical cleaning, so that not only a lot of time is taken, but also there is a case where the subject portion is not completely removed. Furthermore, when the blocked portion of the porous glass cannot be removed, it is necessary to exchange the porous glass. But, as mentioned above, the manufacturing costs of the porous glass are high, and therefore, expenses for exchanging the porous glass become high.

Meanwhile, in the channel structure described in PTL 2 and the microreactor described in PTL 3, if the substrate having a groove formed therein and the substrate for covering the opening of the groove are prepared, the channel structure and the microreactor can be easily formed, and therefore, the manufacturing costs are low. In addition, by dividing the channel structure and the microreactor into the substrate having a groove formed therein and the substrate for covering the opening of the groove, foreign matters blocking the channel can be easily removed, and therefore, the maintenance of the channel structure and the microreactor is easy. But, in the channel structure described n PTL 2 and the microreactor described in PTL 3, the flow-through rate of the fluid is small, so that the treatment amount of the fluid is small.

Under such circumstances, the present invention has been made, and an object thereof is to provide a fluid flow-through device and a photochemical reactor, in which a flow-through rate of a fluid is large, the manufacturing costs are low, and the maintenance is easy.

### Solution to Problem

The present inventors have found that by disposing an inner tube inside an outer tube and forming a channel of a fluid on an inner surface of the outer tube and an outer surface of the inner tube, a fluid flow-through device and a photochemical reactor, in which a flow-through rate of a fluid is large, the manufacturing costs are low, and the maintenance is easy, can be produced, leading to accomplishment of the present invention. Specifically, the present invention provides the following [1] to [21] inventions.

[1] A fluid flow-through device including an outer tube having an outer surface and an inner surface; and either an inner tube having an outer surface and an inner surface, the inner tube being disposed inside the outer tube and forming a channel of a fluid by the inner surface of the outer tube and the outer surface of the inner tube, or a rod-shaped body having an outer surface, the rod-shaped body being disposed inside the outer tube and forming a channel of a fluid by the inner surface of the outer tube and the outer surface of the rod-shaped body, with a distance between the inner surface of the outer tube and the outer surface of the inner tube or the rod-shaped body in a thickness direction of the outer tube being from 100 nm to 5 mm.
[2] The fluid flow-through device as set forth above in [1], wherein the distance between the inner surface of the outer tube and the outer surface of the inner tube or the rod-shaped body in a thickness direction of the outer tube is from 1 μm to 1 mm.
[3] The fluid flow-through passage as set forth above in [1] or [2], wherein the outer tube, or the inner tube or the rod-shaped body rotates in a circumferential direction, or both the outer tube and the inner tube or the rod-shaped body rotate in a circumferential direction and mutually opposite directions.
[4] The fluid flow-through passage as set forth above in [3], wherein a rotation direction of the outer tube, or the inner tube or the rod-shaped body is periodically reversed.
[5] The fluid flow-through passage as set forth above in any of [1] to [4], further including a ring-shaped tool disposed outside the outer tube such that its center is coincident with a central axis of the outer tube; a magnet fixed to the inner tube and disposed in the interior of the inner tube; a magnet disposed inside the ring-shaped tool so as to form an N—S pair with and oppose to the magnet disposed in the interior of the inner tube; and a rotation unit that rotates the ring-shaped tool in a circumferential direction, in which when the ring-shaped tool is rotated in the circumferential direction, the inner tube rotates in the circumferential direction.
[6] The fluid flow-through device as set forth above in any of [1] to [5], wherein at least a part of the outer tube, or the inner tube or the rod-shaped body is constituted of a porous material.
[7] The fluid flow-through device as set forth above in [6], wherein the porous material is a porous ceramic material, a porous glass material, a porous metal material, or a porous resin material.
[8] The fluid flow-through device as set forth above in [7], wherein the porous material includes a porous resin material at least one selected from the group consisting of polytetrafluoroethylene, polychlorotrifluoroethylene, polyvinylidene fluoride, polyvinylidene chloride, polyvinyl chloride, Nafion (R), a polyfluoroethylene propene copolymer, a perfluoroalkoxyalkane, an ethylene/tetrafluoroethylene copolymer, a tetrafluoroethylene-perfluorodioxol copolymer, a polyetherketone, a polyimide, polybutylene naphthalate, a polyether sulfone, an aromatic polyester, a polyamide, a nylon, polyvinylpyrrolidone, a polyallylamine, polystyrene and a substitution product thereof, polyethylene, polyvinyl alcohol, polypropylene, and a polycarbonate, or a copolymer containing a part thereof.
[9] The fluid flow-through device as set forth above in [7], wherein the porous material is a metal-made porous material, a metal fine powder sintered porous body, a metal coil filter, a porous structure in which an organic surface treating agent is applied onto the surface of such a porous metal material, a porous structure in which a polymer thin film is formed on the surface of such a porous metal material, or a porous structure in which a surface coating layer of an inorganic compound is formed on the surface of such a porous metal material.
[10] The fluid flow-through device as set forth above in any of [1] to [4], wherein a cross-sectional shape of the inner surface of the outer tube in a vertical direction to an axial direction of the outer tube is circular or elliptic; and a cross-sectional shape of the outer surface of the inner tube in a vertical direction to an axial direction of the inner tube, or a cross-sectional shape of the rod-shaped body in a vertical direction to an axial direction thereof, is circular or elliptic.
[11] The fluid flow-through device as set forth above in any of [1] to [4], wherein a cross-sectional shape of the inner surface of the outer tube in a vertical direction to an axial direction of the outer tube is polygonal; and a cross-sectional shape of the outer surface of the inner tube in a vertical direction to an axial direction of the inner tube, or a cross-sectional shape of the rod-shaped body in a vertical direction to an axial direction thereof, is polygonal.
[12] The fluid flow-through device as set forth above in any of [1] to [11], further including a spacer for narrowing a width of a channel in a thickness direction of the outer tube, the spacer being disposed on at least one surface of the inner surface of the outer tube and the outer surface of the inner tube or the rod-shaped body.
[13] A photochemical reactor including the fluid flow-through device as set forth above in any of [1] to [12] and a photocatalyst disposed on at least one surface of the inner surface of the outer tube and the outer surface of the inner tube or the rod-shaped body.
[14] The photochemical reactor as set forth above in [13], further including a light source radiating light that transmits through the inner tube to excite the photocatalyst, the light source being disposed inside the inner tube.
[15] The photochemical reactor as set forth above in [13], further including a light source radiating light that transmits through the outer tube to excite the photocatalyst, the light source being disposed outside the outer tube.
[16] The photochemical reactor as set forth above in any of [13] to [15], wherein the photocatalyst is titanium oxide.
[17] The photochemical reactor as set forth above in any of [13] to [16], wherein the photocatalyst is titanium oxide containing 50% or more of brookite-type titanium oxide.
[18] The photochemical reactor as set forth above in any of [13] to [16], wherein the photocatalyst is titanium oxide manufactured by the vapor deposition method.
[19] A photochemical reactor including the fluid flow-through device as set forth above in any of [1] to [12]; and a light source on the outside of the outer tube, thereby enabling the outer tube to transmit light, a light source on the inside of the inner tube, thereby enabling the inner tube to transmit light, or light sources on the outside of the outer tube and on the inside of the inner tube, thereby enabling the outer tube and the inner tube to transmit light.
[20] The photochemical reactor as set forth above in [19], wherein a material of the outer tube or a material of the inner tube or the rod-shaped body is a quartz glass.
[21] The photochemical reactor as set forth above in any of [1] to [18], including a light source on the outside of the outer tube, thereby enabling the outer tube to transmit light, a light source on the inside of the inner tube, thereby enabling the inner tube to transmit light, or light sources on the outside of the outer tube and on the inside of the inner tube, thereby enabling the outer tube and the inner tube to transmit light.

### Advantageous Effects of Invention

In accordance with the present invention, it is possible to provide a fluid flow-through device and a photochemical reactor, in which a flow-through rate of a fluid is large, the manufacturing costs are low, and the maintenance is easy.

### BRIEF DESCRIPTION OF DRAWINGS

FIG. 1 is a perspective view of a fluid flow-through device in an embodiment of the present invention.

FIG. 2 is a perspective view of a modification of a fluid flow-through device in an embodiment of the present invention.

FIG. 3 is a perspective view of a modification of a fluid flow-through device in an embodiment of the present invention.

FIG. 4 is a perspective view of a modification of a fluid flow-through device in an embodiment of the present invention.

FIG. 5 is a perspective view of a modification of a fluid flow-through device in an embodiment of the present invention.

FIG. 6 is a cross-sectional view of a modification of a fluid flow-through device in an embodiment of the present invention.

FIG. 7 is a cross-sectional view of a modification of a photochemical reactor in an embodiment of the present invention.

### DESCRIPTION OF EMBODIMENTS

A photochemical reaction in an embodiment of the present invention and a fluid flow-through device in an embodiment of the present invention are hereunder described by reference to the accompanying drawings.

### [Photochemical Reactor]

A photochemical reactor in an embodiment of the present invention includes a fluid flow-through device in an embodiment of the present invention and a photocatalyst.

### (Fluid Flow-through Device)

As shown in FIG. 1, a fluid flow-through device 1 in an embodiment of the present invention includes an outer tube 2 having an outer surface 21 and an inner surface 22; and an inner tube 3 having an outer surface 31 and an inner surface 32, the inner tube 3 being disposed inside the outer tube 2 and forming a channel 4 of a solution by the inner surface 22 of the outer tube 2 and the outer surface 31 of the inner tube 3. According to this, a fluid can be allowed to flow through over a wide range of a space formed by the inner surface 22 of the outer tube 2 and the outer surface 31 of the inner tube 3, and therefore, a flow-through rate of the fluid can be made large. The fluid flows in the channel 4 in axial directions of the outer tube 2 and the inner rube 3. By producing the outer tube 2 having a predetermined inner diameter and the inner tube 3 having a predetermined outer diameter, the channel 4 having a small width in a thickness direction of the outer tube 2 can be formed, and therefore, the manufacturing costs of the fluid flow-through device 1 can be decreased. Furthermore, in maintenance of the photochemical reactor, in the case of removing a blocked portion of the channel 4 of the fluid flow-through device 1, when the inner tube 3 disposed inside the outer tube 2 is taken away from the outer tube 2, and the outer tube 2 and the inner tube 3 are cleaned, the blocked portion of the channel 4 can be easily removed. As mentioned above, since the manufacturing costs of the fluid flow-through device 1 are inexpensive, in maintenance of the photochemical reactor, even in the case of exchanging the outer tube 2 and/or the inner tube 3, the exchange expenses can be decreased.

In past microchannel reactors, since the solution comes into contact with, in addition to an upper surface and a bottom surface of the channel, a side wall, when the channel length becomes long, a pressure loss becomes large. But, in the fluid flow-through device 1 in the embodiment of the present invention, since the side wall does not actually exist in the channel 4, a pressure loss originated from the side wall does not theoretically exist. From this fact, the pressure loss at least becomes ½ of that in a usual microchannel reactor having the same channel length. Meanwhile, the contact with the upper surface (inner surface 22 of the outer tube 2) or bottom surface (outer surface 31 of the inner tube 3) is good, and it is possible to enhance light transmission properties as mentioned later, or gas permeability when a porous tube described in modifications as mentioned later is used.

In the case of irradiating light from the outside of the outer tube 2 of the fluid flow-through device 1 to excite the photocatalyst of the photochemical reactor, the outer tube 2 is preferably a material that transmits the light exciting the photocatalyst. Examples of the material of the outer tube 2 include glasses, such as a quartz glass, a silica glass, a soda lime glass, a borosilicate glass, an aluminosilicate glass, etc.; resins, such as at least one selected from the group consisting of polymethyl methacrylate, a polycarbonate, a cycloolefin polymer, an alicyclic acrylic resin, a fluorocarbon resin, a polyimide, an epoxy resin, an unsaturated polyester, a vinyl ester resin, a styrene polymer, polyethylene terephthalate, polyethylene, polychlorotrifluoroethylene, polyvinylidene fluoride, polyvinylidene chloride, polyvinyl chloride, Nafion (R), a polyfluoroethylene propene copolymer, a perfluoroalkoxyalkane, an ethylene/tetrafluoroethylene copolymer, a tetrafluoroethylene-perfluorodioxol copolymer, a polyetherketone, polybutylene naphthalate, a polyether sulfone, an aromatic polyester, a polyamide, a nylon, polyvinylpyrrolidone, a polyallylamine, polystyrene and a substitution product thereof, polyethylene, polyvinyl alcohol, polypropylene, and a polycarbonate, or a copolymer containing a part thereof; and the like. In view of the fact that a wavelength band of the light to be transmitted is broad, and in addition, from the viewpoint of heat resistance, a more preferred material of the outer tube 2 is a quartz glass. In this case, the inner tube 3 may not transmit the light exciting the photocatalyst. Examples of a material of the inner tube 3 include a glass, a metal, a resin, a ceramic, a wood, and composite materials thereof, and the like. The material of the inner tube 3 may be the same material as the material of the outer tube 2. The material of the inner tube 3 is more preferably a resin. When the material of the inner tube 3 is a resin, by heating the inner tube 3 to a temperature in the vicinity of a softening point of the resin to close the both ends of the inner tube 3 and applying a pressure thereto, a distance between the inner surface 22 of the outer tube 2 and the outer surface 31 of the inner tube 3 in a thickness direction of the outer tube can be adjusted.

In the case of irradiating light from the inside of the inner tube 3 of the fluid flow-through device 1 to excite the photocatalyst of the photochemical reactor, the inner tube 3 is preferably a material that transmits the light exciting the photocatalyst. Examples of the material of the inner tube 3 include glasses, such as a quartz glass, a silica glass, a soda lime glass, a borosilicate glass, an aluminosilicate glass, etc.; resins, such as at least one selected from the group consisting of polymethyl methacrylate, a polycarbonate, a cycloolefin polymer, an alicyclic acrylic resin, a fluorocarbon resin, a polyimide, an epoxy resin, an unsaturated polyester, a vinyl ester resin, a styrene polymer, polyethylene terephthalate, polyethylene polychlorotrifluoroethylene, polyvinylidene fluoride, polyvinylidene chloride, polyvinyl chloride, Nafion (R), a polyfluoroethylene propene copolymer, a perfluoroalkoxyalkane, an ethylene/tetrafluoroethylene copolymer, a tetrafluoroethylene-perfluorodioxol copolymer, a polyetherketone, polybutylene naphthalate, a polyether sulfone, an aromatic polyester, a polyamide, a nylon, polyvinylpyrrolidone, a polyallylamine, polystyrene and a substitution product thereof, polyethylene, polyvinyl alcohol, polypropylene, and a polycarbonate, or a copolymer containing a part thereof; and the like. In view of the fact that a wavelength band of the light to be transmitted is broad, a more preferred material of the inner tube 3 is a quartz glass. In this case, the outer tube 2 may not transmit the light exciting the photocatalyst. Examples of a material of the outer tube 2 include a glass, a metal, a resin, a ceramic, a wood, and the like. The material of the outer tube 2 may be the same material as the material of the inner tube 3. The material of the outer tube 2 is more preferably a resin. When the material of the outer tube 2 is a resin, by heating the outer tube 2 to a temperature in the vicinity of a softening point of the resin to suck the outer tube 2 or thermally shrinking the outer tube 2, a distance between the inner surface 22 of the outer tube 2 and the outer surface 31 of the inner tube 3 in the thickness direction of the outer tube can be adjusted.

Although the distance between the inner surface 22 of the outer tube 2 and the outer surface 31 of the inner tube 3 in the thickness direction of the outer tube varies depending upon an application of the fluid flow-through device, an application of the photochemical reactor, a wavelength of the selected light, light transmission properties of a reaction liquid, and so on, it is from 100 nm to 5 mm, preferably from 1 μm to 1 mm, and more preferably from 10 μm to 0.5 mm. When the distance between the inner surface 22 of the outer tube 2 and the outer surface 31 of the inner tube 3 in the thickness direction of the outer tube is smaller than 100 nm, there is a case where the solution hardly flows in the channel 4. When the distance between the inner surface 22 of the outer tube 2 and the outer surface 31 of the inner tube 3 in the thickness direction of the outer tube is more than 5 mm, there is a case where the light for exciting the photocatalyst does not transmit into the solution flowing in the channel 4. When the light for exciting the photocatalyst does not transmit into the solution flowing in the channel 4, there is a case where it is difficult to excite the photocatalyst disposed on at least one surface of the inner surface 22 of the outer tube 2 and the outer surfaces 31 of the inner tube 3 as mentioned later with the light. According to the fluid flow-through device in the embodiment of the present invention, the channel 4 having such a small width in the thickness direction of the outer tube 2 can be easily formed.

As in a photoreactor described in FIG. 13 of the aforementioned PTL 1, when particles and/or a porous body is filled between the inner surface of the outer tube and the outer surface of the inner tube, the manufacturing costs of the photochemical reactor become high, and the maintenance becomes difficult. In consequence, particles and/or a porous body is not filled in the channel formed between the inner surface 22 of the outer tube 2 and the outer surface 31 of the inner tube 3.

On the inner surface 22 of the outer tube 2 or the outer surface 31 of the inner tube 3, fine irregularities of 10 to 100 μm or a porous glass layer having a thickness of 10 to 100 μm may be formed. When the inner tube 3 is taken out from the interior of the outer tube 2, such irregularities or porous glass layer is detached from an opposite surface, and therefore, cleaning for removal of a blockage that blocks the channel 4 or removal of a fouling substance on the channel surface can be easily performed. In consequence, as compared with the photoreactor described in the aforementioned PTL 1, the fluid flow-through device 1 in the embodiment of the present invention has both novelty and inventive step.

A cross-sectional shape of the inner surface 22 of the outer tube 2 in a vertical direction to an axial direction of the outer tube 2 is preferably circular, and a cross-sectional shape of the outer surface 31 of the inner tube 3 in a vertical direction to an axial direction of the inner tube 3 is preferably circular. According to this, the flow of a solution flowing in the channel 4 formed by the inner surface 22 of the outer tube 2 and the outer surface 31 of the inner tube 3 in the axial directions of the outer tube 2 and the inner tube 3 can be made uniform. The cross-sectional shape of the inner surface of the outer tube 2 in a vertical direction to the axial direction of the outer tube 2 may also be elliptic, and the cross-sectional shape of the outer surface of the inner tube 3 in a vertical direction to the axial direction of the inner tube may also be elliptic.

### (Photocatalyst)

The photocatalyst is disposed on at least one of the inner surface 22 of the outer tube 2 and the outer surface 31 of the inner tube 3. According to this, the solution flowing in the channel 4 formed by the inner surface 22 of the outer tube 2 and the outer surface 31 of the inner tube 3 can be treated with the photocatalyst. For example, in the case where the solution is water, the water can be purified.

Examples of the photocatalyst that is disposed on at least one of the inner surface 22 of the outer tube 2 and the outer surface 31 of the inner tube 3 include a titanium oxide-based photocatalyst and a tungsten oxide-based photocatalyst. Examples of the titanium oxide-based photocatalyst include TiO₂, TiO(N)₂Pt/TiO₂, copper-based compound-modified titanium oxide, iron-based compound-modified titanium oxide, metal-modified titanium oxide, copper-based compound-modified tungsten oxide, metal-modified tungsten oxide, tantalum oxynitride, and the like. Examples of TiO₂ include amorphous TiO₂, rutile-type TiO₂, brookite-type TiO₂, anatase-type TiO₂, and the like. Examples of the tungsten oxide-based photocatalyst include Pt/WO₃.

The photocatalyst may be disposed on at least one of the inner surface 22 of the outer tube 2 and the outer surface 31 of the inner tube 3 by supporting it on at least one of the inner surface 22 of the outer tube 2 and the outer surface 31 of the inner tube 3. The photocatalyst may also be disposed on at least one of the inner surface 22 of the outer tube 2 and the outer surface 31 of the inner tube 3 by forming a photocatalyst layer on at least one of the inner surface 22 of the outer tube 2 and the outer surface 31 of the inner tube 3. Specifically, the photocatalyst can be, for example, disposed on the inner surface 22 of the outer tube 2 in the following manner. A colloid dispersion fluid of titanium oxide is filled in the outer tube 2 and allowed to stand for a while, and thereafter, colloid particles of titanium oxide are attached onto the inner surface 22 of the outer tube 2. Then, the colloid dispersion solution of titanium oxide is discharged from the outer tube 2. Subsequently, the outer tube 2 having colloid particles of titanium oxide attached onto the inner surface 22 is dried and then heated, thereby forming a titanium oxide layer on the inner surface 22 of the outer tube 2. In this way, the photocatalyst can be disposed on the inner surface 22 of the outer tube 2.

The photocatalyst is preferably one formed of colloid particles. According to this, when an electron and a hole as photoproduced move onto the surface of the photocatalyst, a moving distance may be shortened. As the titanium oxide in a colloid particle state, titanium oxide containing, as a main component, brookite-type titanium oxide is preferred. It is known that the brookite-type titanium oxide becomes a particle with good water dispersibility, and on processing for disposing titanium oxide on the surface of the photochemical reactor in the embodiment of the present invention, the brookite-type titanium oxide is favorable. Whether or not the titanium oxide of colloid particles as produced is brookite-type titanium oxide can be determined by drying and then pulverizing the colloid particles and performing X-ray diffraction measurement, thereby confirming the presence of a peak assigned to the brookite type. Whether or not the brookite-type titanium oxide is a major component in the titanium oxide of colloid particles as produced is understood by calculating a structural ratio of brookite-type titanium oxide/anatase-type titanium oxide/rutile-type titanium oxide by using an already-known method, for example, the Rietveid analysis, etc. When a proportion of the brookite-type titanium oxide as calculated from the structural ratio of titanium oxide is 50% or more, it may be said that the titanium oxide is titanium oxide containing, as a main component, brookite-type titanium oxide. The titanium oxide is preferably one manufactured by the vapor deposition method. According to this, titanium oxide particles which are very fine and high in crystallinity can be obtained. For example, the titanium oxide can be synthesized by heating a vapor of titanium chloride or oxychloride at 500° C. or higher (preferably 800° C. or higher) and oxidizing it with oxygen or in a water vapor. The titanium oxide obtained by such vapor phase method is synthesized in a moment in a high-temperature atmosphere. Thus, while such titanium oxide is fine, it is high in crystallinity and less in lattice defect. For this reason, it may be said that the titanium oxide obtained by the vapor phase method is a suitable material as the photocatalyst that is used for the photochemical reactor of the embodiment of the present invention.

As a light source that excites the photocatalyst, for example, a low-pressure mercury lamp, a black light lamp, LED (light emitting diode), and the like are used. In addition, sunlight may be used as the light source, and the sunlight may also be used as the light source in combination with a low-pressure mercury lamp, a black light lamp, LED (light emitting diode), or the like. In order to control a wavelength of the light radiated from the light source, a cutoff filter, a band-pass filter, a fluid filter, a monochromator, and the like may also be used.

When the solution passes through the channel 4 in which the photocatalyst is disposed on at least one surface of the inner surface 22 of the outer tube 2 and the outer surface 31 of the inner tube 3, fungi, organic matters, and the like in the solution are decomposed by photocatalytic reaction of the photocatalyst. The photochemical reactor in the embodiment of the present invention is preferably used for water purification. For example, a toxic substance such as various environmental estrogens, dioxins, trihalomethanes, bacteria, and the like in the water flowing in the channel 4 is decomposed or inactivated by means of photocatalytic reaction of the photocatalyst.

### [Modifications]

The fluid flow-through device in the embodiment of the present invention and the photochemical reactor in the embodiment of the present invention can be modified as follows.

### (Modification 1 of Fluid Flow-Through Device)

At least a part of the outer tube or the inner tube may be constituted of a porous material. According to this, a gas necessary for the photocatalytic reaction by the photocatalyst can be supplied from the portion of the outer tube or the inner tube constituted of a porous material, or a gas produced by the photocatalytic reaction by the photocatalyst can be recovered from the channel. The aforementioned porous material is not particularly limited so long as it is a porous material capable of separating the liquid and the gas from each other. Examples of the porous material include a porous ceramic material, a porous glass material, a porous metal material, a porous resin material, and the like. The porous material is preferably a porous resin material. Preferred examples of the porous resin material include at least one selected from polytetrafluoroethylene, polychlorotrifluoroethylene, polyvinylidene fluoride, polyvinylidene chloride, polyvinyl chloride, Nafion (R), a polyfluoroethylene propene copolymer, a perfluoroalkoxyalkane, an ethylene/tetrafluoroethylene copolymer, a tetrafluoroethylene-perfluorothoxol copolymer, a polyetherketone, a polyimide, polybutylene naphthalate, a polyether sulfone, an aromatic polyester, a polyamide, a nylon, polyvinylpyrrolidone, a polyallylamine, polystyrene and a substitution product thereof, polyethylene, polyvinyl alcohol, polypropylene, and a polycarbonate, or a copolymer containing a part thereof, and the like. The porous resin material is more preferably polytetrafluoroethylene. Examples of the gas that is supplied into the solution through the porous material include oxygen, carbon dioxide, nitrogen, argon, and the like. An average pore diameter, a pore diameter distribution, and a porosity of the porous material are not particularly limited so long as they are an average pore diameter, a pore diameter distribution, and a porosity, respectively, upon which the gas and the liquid can be separated from each other. The porous material may be a metal-made porous material, a metal fine powder sintered porous body, a metal coil filter, a porous structure in which an organic surface treating agent is applied onto the surface of such a porous metal material, a porous structure in which a polymer thin film is formed on the surface of such a porous metal material, or a porous structure in which a surface coating layer of an inorganic compound is formed on the surface of such a porous metal material.

In the case where at least a part of the outer tube is a porous material, nitrogen, an oxygen gas, a carbon dioxide gas, and the like contained in the environment of the fluid flow-through device can be supplied into the solution flowing in the channel through the porous material of the outer tube. When a tube surrounding the outer tube is further installed outside the outer tube, by allowing a gas to pass through in a channel formed by a gap between the foregoing tube and the outer tube, the aforementioned gas can be supplied into the solution flowing in the channel between the outer tube and the inner tube. Furthermore, by setting the channel formed by a gap between the tube surrounding the outer tube and the outer tube at a negative pressure, a gas produced from the solution flowing in the channel between the outer tube and the inner tube can be recovered through the channel formed by a gap between the tube surrounding the outer tube and the outer tube. It is possible to contain an evaporated vapor of a solvent, and according to this, it becomes possible to concentrate the solution. In this way, in the case of allowing the solution or gas flowing in the channel between the outer tube and the inner tube to react by the structure of the tube surrounding the outer tube, the outer tube, and the inner tube, particularly under chemical equilibrium conditions, it is possible to appropriately control the concentration of the solution over all elapsed time, whereby the treatment efficiency of the solution can be enhanced. Furthermore, by reducing the pressure of the outside of the outer tube, it becomes possible to partially distil off the solvent from the solution flowing in the channel, whereby it becomes possible to concentrate the solution flowing in the channel. The solution flowing in the channel between the outer tube and the inner tube, the gas flowing in the channel between the tube surrounding the outer tube and the outer tube, and the light radiated from the interior of the inner tube are completely separated from supply paths of the solution, the gas, and the light, respectively. In consequence, by independently controlling each of a flow rate of the solution, a flow rate of the gas, and an irradiation amount of the light, it is possible to control more minutely the photocatalytic reaction of the photocatalyst.

As mentioned above, in the case of irradiating light from the inside of the inner tube of the fluid flow-through device to excite the photocatalyst of the photochemical reactor, the outer tube may not transmit the light exciting the photocatalyst. In this case, at least a part of the outer tube may be a porous material.

As mentioned above, in the case of irradiating light from the outside of the outer tube of the fluid flow-through device to excite the photocatalyst of the photochemical reactor, the inner tube may not transmit the light exciting the photocatalyst. In this case, at least a part of the inner tube may be a porous material. In particular, by using an inner tube of a porous material as the inner tube of the fluid flow-through device, a gas can be supplied into the solution, or a gas produced from the solution can be recovered through the inner tube. In this case, the inner tube itself forms a channel for supplying or recovering the gas. Thus, similar to the case where at least a part of the outer tube is a porous material, a separate tube, such as a tube surrounding the outer tube, etc., may not be installed for the purpose of forming a channel for supplying or recovering a gas.

### (Modification 2 of Fluid Flow-through Device)

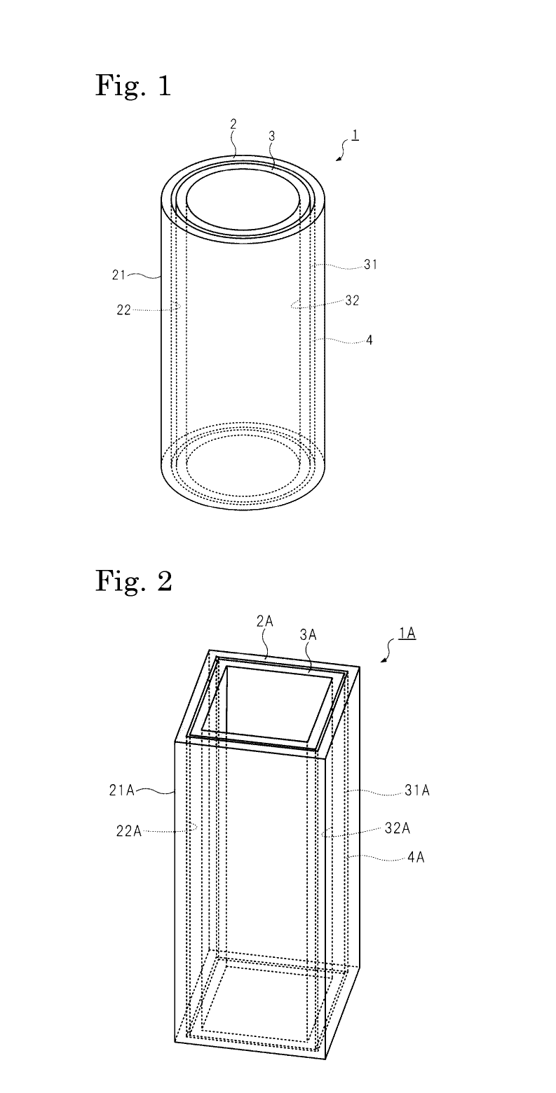

In the aforementioned fluid flow-through device 1, the cross-sectional shape of the inner surface 21 of the outer tube 2 in the vertical direction to the axial direction of the outer tube 2 was circular or elliptic, and the cross-sectional shape of the outer surface 31 of the inner tube 3 in the vertical direction to the axial direction of the inner tube 3 was circular or elliptic. But, in the fluid flow-through device 1, the cross-sectional shape of the inner surface of the outer tube in the vertical direction to the axial direction of the outer tube may be polygonal, and also, the cross-sectional shape of the outer surface of the inner tube in the vertical direction to the axial direction of the inner tube may be polygonal. For example, as in a fluid flow-through device 1A shown in FIG. 2, a cross-sectional shape of an inner surface 22A of an outer tube 2A in a vertical direction to an axial direction of the outer tube 2A may be quadrangular, and also, a cross-sectional shape of an outer surface 31A of an inner tube 3A in a vertical direction to an axial direction of the inner tube 3A may be quadrangular. In FIG. 2, a symbol 21A expresses an outer surface of the outer tube 2A, and a symbol 32A expresses an inner surface of the inner tube 3A. Furthermore, a symbol 4A expresses a channel formed by the inner surface 22A of the outer tube 2A and the outer surface 31A of the inner tube 3A.

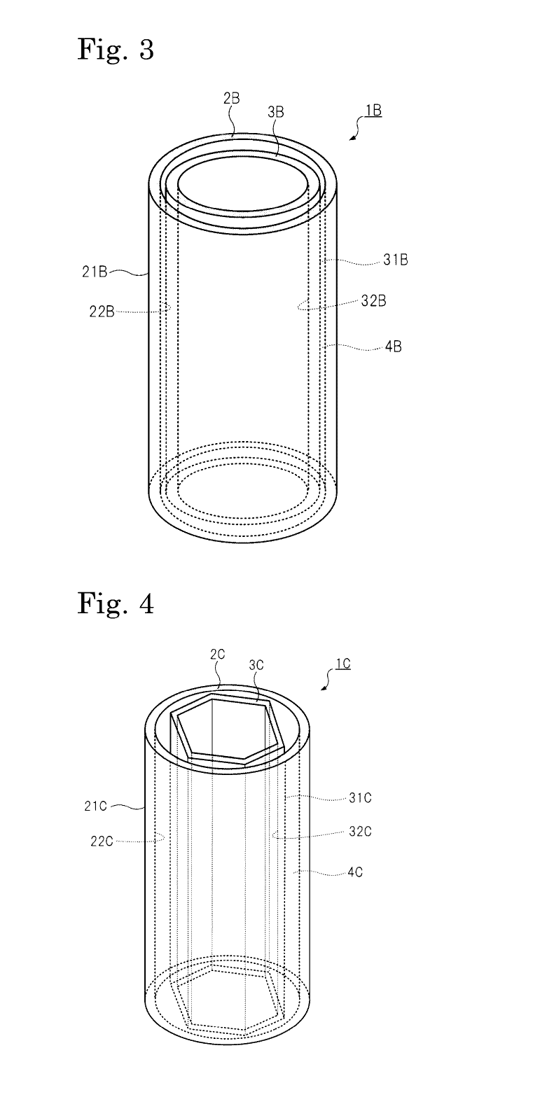

In the fluid flow-through device 1, the cross-sectional shape of the inner surface 21 of the outer tube 2 in the vertical direction to the axial direction of the outer tube 2 may not be identical with the cross-sectional shape of the outer surface 31 of the inner tube 3 in the vertical direction to the axial direction of the inner tube 3. For example, as in a fluid flow-through device 1B shown in FIG. 3, a cross-sectional shape of an inner surface 22B of an outer tube 2B in a vertical direction to an axial directional of the outer tube 2B may be circular, whereas a cross-sectional shape of an outer surface 31B of an inner tube 3B in a vertical direction to an axial direction of the inner tube 3B may be elliptic. In FIG. 3, a symbol 21B expresses an outer surface of the outer tube 2B, and a symbol 32B expresses an inner surface of the inner tube 3B. Furthermore, a symbol 4B expresses a channel formed by the inner surface 22B of the outer tube 2B and the outer surface 31B of the inner tube 3B.

In addition, as in a fluid flow-through device 1C shown in FIG. 4, a cross-sectional shape of an inner surface 22C of an outer tube 2C in a vertical direction to an axial directional of the outer tube 2C may be circular, whereas a cross-sectional shape of an outer surface 31C of an inner tube 3C in a vertical direction to an axial direction of the inner tube 3C may be hexagonal. In FIG. 4, a symbol 21C expresses an outer surface of the outer tube 2C, and a symbol 32C expresses an inner surface of the inner tube 3C. Furthermore, a symbol 4C expresses a channel formed by the inner surface 22C of the outer tube 2C and the outer surface 31C of the inner tube 3C.

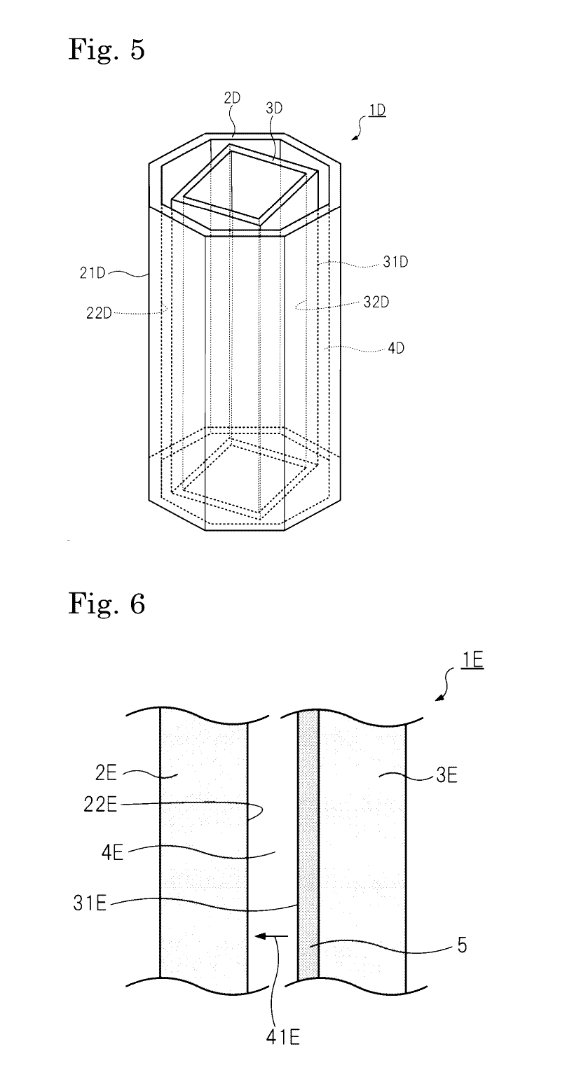

Furthermore, as in a fluid flow-through device 1D shown in FIG. 5, a cross-sectional shape of an inner surface 22D of an outer tube 2D in a vertical direction to an axial directional of the outer tube 2D may be octagonal, whereas a cross-sectional shape of an outer surface 31D of an inner tube 3D in a vertical direction to an axial direction of the inner tube 3D may be quadrangular. In FIG. 5, a symbol 21D expresses an outer surface of the outer tube 2D, and a symbol 32D expresses an inner surface of the inner tube 3D. Furthermore, a symbol 4D expresses a channel formed by the inner surface 22D of the outer tube 2D and the outer surface 31D of the inner tube 3D.

### (Modification 3 of Fluid Flow-through Device)

The fluid flow-through device in the embodiment of the present invention may further include a spacer for narrowing a width of a channel in a thickness direction of the outer tube, the spacer being disposed on at least one surface of the inner surface of the outer tube and the outer surface of the inner tube. According to this, it becomes possible to control more minutely the width of the channel in the thickness direction of the outer tube. For example, as shown in a fluid flow-through device 1E shown in FIG. 6, a spacer 5 may be disposed on an outer surface 31E of an inner tube 3E, thereby narrowing a width of a channel 4E formed by an inner surface 22E of an outer tube 2E and the outer surface 31E of the inner tube 3E in a thickness direction 41E of the outer tube 2E. For example, a resin film, a woven fabric, a nonwoven fabric, or the like can be used as the spacer.

### (Modification 4 of Fluid Flow-through Device)

In the foregoing, the fluid flow-through device of the embodiment of the present invention and Modifications 1 to 4 of the aforementioned fluid flow-through device were used for the photochemical reactor. But, the application of the fluid flow-through device of the embodiment of the present invention and Modifications 1 to 3 of the aforementioned fluid flow-through device is not limited to the photochemical reactor. For example, the application of the fluid flow-through device of the embodiment of the present invention and Modifications 1 to 3 of the aforementioned fluid flow-through device can be used as a fluid flow-through device which is used for continuous raw material supply, product recovery, concentration, and purification steps of a microchannel type reactor.

In the case where at least a part of the outer tube or the inner tube is constituted of a porous material, by using, as the porous material, a hydrophilic and/or ion-exchangeable porous membrane of a fluorine-based polymer material, it is possible to achieve concentration control, supply, recovery, and separation of an ionic substance, a hydrophilic raw material, and a product. For example, at a final stage of the reactor, by carrying out a vacuum concentration step of the solvent component using Modification 1 of the fluid flow-through device of the embodiment of the present invention, a concentrated product solution can be recovered.

### (Modification 5 of Fluid Flow-through Device)

The inner tube was disposed inside the fluid flow-through passage of the foregoing embodiment. But, a rod-shaped body may be disposed in place of the inner tube. In this case, a channel can also be formed by an inner surface of an outer tube and an outer surface of a rod-shaped body. Examples of the rod-shaped body include a cylinder, a prism, and the like. As a material of the rod-shaped body, the same material as in the inner tube 3 in the aforementioned case of irradiating light from the outside of the outer tube 2 of the fluid flow-through device 1 to excite the photocatalyst of the photochemical reactor may be used. At least a part of the rod-shaped body may be constituted of a porous material. According to this, a gas necessary for the photocatalytic reaction by the photocatalyst can be supplied from the portion of the rod-shaped body constituted of a porous material, or a gas produced by the photocatalytic reaction by the photocatalyst can be recovered from the channel.

### (Modification 6 of Fluid Flow-through Device)

In the foregoing, the phase of the substance flowing in the channel of the fluid flow-through passage has been described by reference to the liquid that is a solution. But, the phase of the substance flowing in the channel of the fluid flow-through passage is not limited to the liquid so long as it is a fluid. For example, a gas may flow in the channel of the fluid flow-through passage.

### (Modification 7 of Fluid Flow-through Device)

In order to accelerate stirring of the fluid flowing in the channel of the fluid flow-through passage, the inner tube may be rotated in a circumferential direction. In particular, in the case of applying the catalyst onto the outer surface of the inner tube, the contact between the photocatalyst and the fluid can be accelerated according to this. For example, the inner tube can be rotated in the following way. A magnet is disposed in the interior of the inner tube and fixed to the inner tube. A ring-shaped tool is disposed outside the outer tube such that its center is coincident with a central axis of the outer tube. A magnet having an opposite magnetic polarity is disposed inside the ring-shaped tool. Specifically, the magnet of the ring-shaped tool is disposed so as to form an N—S pair with and oppose to the magnet disposed in the interior of the inner tube. When the ring-shaped tool is rotated in the circumferential direction using a rotation unit, such as a motor, etc., the magnet installed in the interior of the inner tube also rotates by a magnetic force of the magnet provided in the ring-shaped tool. Since the magnet installed in the interior of the inner tube is fixed to the inner tube, the inner tube also rotates together. According to this, the inner tube can be rotated in a non-contact state. The magnet is preferably a magnet having a strong magnetic force, and for example, it is a rare-earth magnet.

When a viscosity of the fluid flowing in the channel of the fluid flow-through passage becomes high, a stress necessary for rotating the inner tube becomes large. A rotational force of the inner tube capable of being given due to the rotation of the ring-shaped tool varies with the magnetic force between the magnet provided in the ring-shaped tool and the magnet installed in the interior of the inner tube. For this reason, the number of magnets provided in the ring-shaped tool and/or magnets installed in the interior of the inner tube may be varied according to the viscosity of the fluid flowing in the channel of the fluid flow-through passage. In order to inhibit twisting of a conduit connected to the fluid flow-through device, a rotation direction of the inner tube may be periodically reversed.

In place of the inner tube, the outer tube may be rotated in a circumferential direction. In particular, in the case of applying the photocatalyst onto the inner surface of the outer tube, the contact between the photocatalyst and the fluid can be accelerated according to this. In order to inhibit winding of a conduit connected to the fluid flow-through device or twisting of a conduit, a rotation direction of the outer tube may be periodically reversed. Furthermore, both the outer tube and the inner tube may be rotated in the circumferential direction. In this case, it is preferred that the rotation direction of the outer tube is an opposite direction to the rotation direction of the inner tube. According to this, the stirring of the fluid flowing in the channel of the fluid flow-through passage can be more accelerated.

### (Modification 1 of Photochemical Reactor)

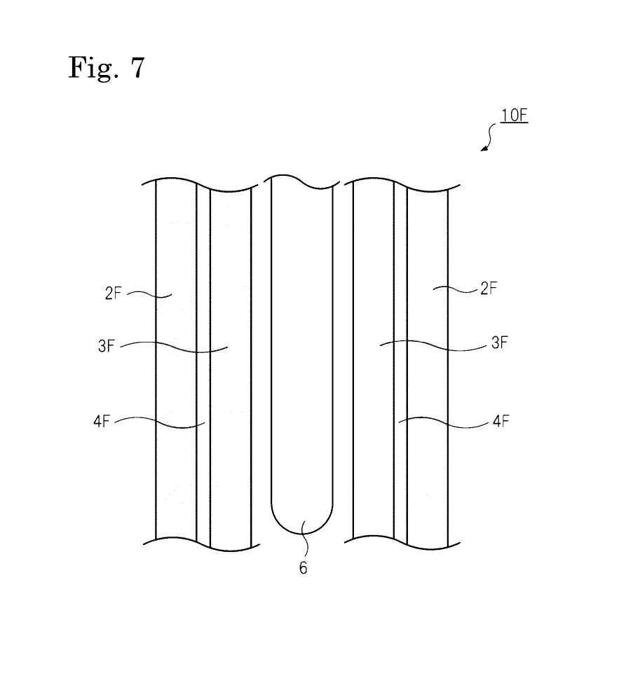

The photochemical reactor of the embodiment of the present invention may further include a light source radiating light that transmits through the inner tube to excite the photocatalyst, the light source being disposed inside the inner tube. For example, as in a photochemical reactor 10F shown in FIG. 7, a light source 6 may be disposed inside an inner tube 3F. The light source 6 is not limited so long as it is one radiating light that transmits through an inner tube 3F to excite the photocatalyst. For example, the light source 6 is a low-pressure mercury lamp, a black light lamp, or LED (light emitting diode). A symbol 2F expresses an outer tube, and a symbol 4F expresses a channel.

### (Modification 2 of Photochemical Reactor)

In the photochemical reactor in the foregoing embodiment, the photocatalyst was disposed on at least one surface of the inner surface of the outer tube and the outer surface of the inner tube. But, in the case of a photochemical reactor that treats a raw material, in which the raw material itself reacts upon irradiation with light, such as a photosensitive raw material, etc., the photocatalyst may not be disposed in the photochemical reactor. The photochemical reactor of this case is, for example, a photochemical reactor including the fluid flow-through device in the embodiment of the present invention and the light source on the outside of the outer tube, the outer tube being able to transmit light; or a photochemical reactor including the fluid flow-through device in the embodiment of the present invention and the light source on the inside of the inner tube, the inner tube being able to transmit light. At this time, light is irradiated from the outside of the outer tube of the fluid flow-through device to excite the raw material in the fluid, or light is irradiated from the inside of the inner tube of the fluid flow-through device to excite the raw material in the fluid. Furthermore, Modification 2 of the photochemical reactor may also be a photochemical reactor including the fluid flow-through device in the embodiment of the present invention, the light source on the outside of the outer tube, and the light source on the inside of the inner tube, the outer tube and the inner tube being able to transmit light.

### (Modification 3 of Photochemical Reactor)

In the foregoing, while the photochemical reactor in which the liquid flows in the channel of the fluid flow-through passage has been described, the fluid flowing in the fluid flow-through passage of the photochemical reactor is not limited to the liquid so long as it is a fluid. For example, a gas may flow in the channel of the fluid flow-through passage of the photochemical reactor. In the case where the fluid is a gas, the photochemical reactor is able to decompose a nitrogen oxide, VOC (volatile organic compound), an odoriferous component, and the like contained in the gas.

The description thus far given is merely exemplary, and the present invention is by no means limited to the aforementioned embodiments. In addition, it is also possible to combine the aforementioned embodiment with the aforementioned modification, or the aforementioned embodiments with each other.

### EXAMPLES

The present invention is hereunder described in more detail with reference to Examples. It should be construed that the following Examples do not limit the present invention.

### Production of Photochemical Reactor of Example 1

### Formation of Photocatalyst Layer of Inner Surface of Outer Tube

6.66 g of an NTB1 colloid dispersion liquid (dispersion liquid of brookite-type titanium oxide nanoparticles), manufactured by Showa Denko Ceramics Co., Ltd., 2.42 g of polyethylene glycol (manufactured by Wako Chemical Industries, Ltd., average molecular weight: 300), 1.01 g of acetylacetone (manufactured by Wako Chemical Industries, Ltd., model number:), and 2.0 g of ethanol (manufactured by Wako Chemical Industries, Ltd., model number: 320-00017) were subjected to a pulverization step using a zirconia-made planetary ball mill (Ito Seisakusho Co., Ltd., model number: LP-1) at 400 rpm for 30 minutes, thereby preparing a coating solution. Subsequently, this coating solution was filled in a quartz glass tube having an outer diameter of 5.9 mm, an inner diameter of 4.5 mm, and a length of 650 mm (manufactured by Fujiwara Scientific Co., Ltd., model number: #4), and after discharging an excess of the solution, the resultant was dried by flowing air using a blower and baked at 450° C. for 2 hours, thereby forming a coating layer of the brookite-type titanium oxide nanop articles on an inner surface of an outer tube. A thin film of the titanium oxide nanoparticles, which was separately formed on a surface of a plate-like Pyrex (registered trademark) substrate by the same procedures, had a coating film strength of 6H by a pencil scratch tester, so that it was confirmed to have a sufficient strength as a photocatalyst layer.

### Assembling of Photochemical Reactor

The aforementioned quartz glass tube in which the coating layer of the brookite-type titanium oxide nanoparticles was formed on the inner surface was used as the outer tube; a glass structure, in which both ends of a quartz glass tube having an outer diameter of 3.9 mm, an inner diameter of 2.5 mm, and a length of 650 mm (manufactured by Fujiwara Scientific Co., Ltd., model number: #2) were heat-sealed, was disposed in the interior thereof; and a joint made of a fluorocarbon resin was installed in each of both ends of the assembly. A 1/16-inch conduit made of Teflon (registered trademark) was connected to each of the joints, and one conduit made of Teflon (registered trademark) was connected to a liquid feeding pump, whereas the other conduit made of Teflon (registered trademark) was connected to a recovery vessel of a product solution. A distance between the inner surface of the outer tube and the outer surface of the inner tube of this fluid flow-through device was about 500 μm in average; a measured whole volume of a channel formed by the inner surface of the outer tube and the outer surface of the inner tube was 3.6 mL; an area of a light-receiving window of the outer tube receiving light from a light source was 82 cm²; and a (light-receiving window area)/(channel volume) ratio was 2,290 m⁻¹. This area of the light-receiving window of the outer tube was a light-receiving area larger than that in a microchannel reactor.

Although a light-receiving part of a past microchannel reactor receives light from one surface of a channel heat-sealed on a glass plate, the light having entered the glass portion between the channels transmits as it is. However, in the photochemical reactor of Example 1, since the whole of light having entered from the surface of the outer tube flows in the channel and is irradiated in the vessel, a light-receiving area per unit structure becomes at least two times. Similarly, in the case of a photochemical reactor constructed by winding a tube made of Teflon (registered trademark) around a mercury lamp, since the light-receiving area is small in proportion to a thickness of the Teflon (registered trademark) tube, the light-receiving area of the photochemical reactor becomes approximately two times.

### Production of Photochemical Reactor of Comparative Example 1

A photochemical reactor of Comparative Example 1 was produced in the same method as the production method of the photochemical reactor of Example 1, except that the coating layer of titanium oxide nanop articles was not formed on the inner surface of the outer tube.

### Production of Photochemical Reactor of Comparative Example 2

A photochemical reactor of Comparative Example 2 was produced in the same method as the production method of the photochemical reactor of Example 1, except that the inner tube was not provided.

### Reaction Activity Evaluation 1

Using each of the photochemical reactors as produced above, water was purified to evaluate the photochemical reactor. To water to which is subjective to the purification, 4-chlorophenol (corresponding to the phenol (0.005 mg/L or less as converted into the amount of phenol) of The Water Quality Standard Items and Standard Values (51 Items) of Water Supply of the Ministry of Health, Labour and Welfare) that is a typical water-soluble contaminant was added. As a light source for exciting the photocatalyst, six 20 W black light lamps (manufactured by Toshiba Corporation, model number: FL20S BLB) were used. The aforementioned six black light lamps were disposed surrounding the aforementioned glass tube in parallel to the aforementioned glass tube. After lighting the six black light lamps, water containing 4-chlorophenol in a concentration of 100 μM was allowed to flow through into the channel of the photochemical reactor. By changing a flow rate of the water flowing in the channel to 10 mL/min, 5 mL/min, and 1 mL/min, respectively, the water was treated using the photochemical reactor.

The water treated with the photochemical reactor was collected, its concentration of 4-chlorohenol was measured using a high-performance liquid chromatograph (manufactured by JASCO Corporation, model number: 875-UV), thereby examining a conversion of 4-chlorophenol. When 4-chlorophenol is completely decomposed, it is converted into carbon dioxide. However, during a time of decomposition of 4-chlorophenol into carbon dioxide, it is expected that phenol, catechol, hydroquinone, and the like are formed as intermediates. Slight amounts of phenol, catechol, and hydroquinone were detected from the water treated with the photochemical reactor. From this fact, it is conjectured that the 4-chlorophenol was decomposed step-by-step into carbon dioxide through a dechlorination process by photocatalytic reaction.

### Evaluation Result 1

The conversion of 4-chlorophenol by the photochemical reactor of Example 1 was 6% at a flow rate of water of 10 mL/min, 9% at a flow rate of water of 5 mL/min, and 32% at a flow rate of water of 1 mL/min, respectively. Meanwhile, the conversion of 4-chlorophenol by the photochemical reactor of Comparative Example 1 under conditions of not irradiating light was 1% at a flow rate of water of 10 mL/min, 1% at a flow rate of water of 5 mL/min, and 1% at a flow rate of water of 1 mL/min, respectively. According to this, it was confirmed that in the photochemical reactor of Comparative Example 1, the adsorption did not substantially occur. In addition, the conversion of 4-chlorophenol by the photochemical reactor of Comparative Example 2 not provided with an inner tube was 18% at a flow rate of water of 1 mL/min under conditions of a longest residence time. The volume of the photochemical reactor of Comparative Example 2 is 10.3 mL, and as compared with the photoreactor having an inner tube, the time for which the water retained in the channel became 2.8 times. Since the time for which water retains in the photoreactor is corresponding to a time for which the water is irradiated with light, and the amount of light in which the photochemical reactor of Comparative Example 2 receives the light becomes 2.8 times. When comparison is made in terms of reaction efficiency per unit amount of light to be light-received, it was noted that by providing the inner tube inside the outer tube to form the channel, the reaction efficiency became approximately 5 times. According to this, it was noted that by using the photochemical reactor of the present invention, a large number of water-soluble contaminants can be removed from water. In the case where water having a concentration of 4-chlorophenol of 1 mM is allowed to flow through at a flow rate of 1 mL/min into the channel of the photochemical reactor, the conversion of 4-chlorophenol by the photochemical reactor of Example 1 was 7%. This is corresponding to an amount of about 2 times in terms of a decomposition amount of 4-chlorophenol as compared with the case where water having a concentration of 4-chlorophenol of 100 μM is allowed to flow through at a flow rate of 1 mL/min into the channel of the photochemical reactor.

### Production of Photochemical Reactor of Example 2

In the interior of a quartz glass tube having an outer diameter of 6.0 mm, an inner diameter of 4.4 mm, and a length of 650 mm (manufactured by Fujiwara Scientific Co., Ltd., model number: #4), a structure of a transparent quartz glass tube having an outer diameter of 3.8 mm and a length of 650 mm (manufactured by Sansyo Co., Ltd., model number: IQ-2), both ends of which were heat-sealed, was disposed and a joint made of a fluorocarbon resin was installed in each of both ends of the assembly. In this reactor, a photoreactive molecule in a solution is activated upon direct excitation with light, and thus, no photocatalyst layer is provided. A 1/16-inch conduit made of Teflon (registered trademark) was connected to each of the joints, and one conduit made of Teflon (registered trademark) was connected to a syringe pump (manufactured by ISIS Co., Ltd., Fusion Model 100) and a gastight syringe (SGE, 50 mL), whereas the other conduit made of Teflon (registered trademark) was connected to a recovery vessel of a product solution. A distance between the inner surface of the outer tube and the outer surface of the glass rod of this fluid flow-through device was about 300 μm in average; a measured whole volume of a channel formed by the inner surface of the outer tube and the outer surface of the glass rod was 2.2 mL; an area of a light-receiving window of the outer tube receiving light from a light source was 109 cm² as a measured value in a region irradiated with a lamp; and a (light-receiving window area)/(channel volume) ratio was 4,950 m⁻¹. This area of the light-receiving window of the outer tube was a light-receiving area larger than that in a microchannel reactor.

### Production of Photochemical Reactor of Comparative Example 3

A photochemical reactor of Comparative Example 3 was produced in the same method as the production method of the photochemical reactor of Example 2, except that the structure in which the both ends of the transparent quartz glass tube were heat-sealed was not provided. A reactor volume of this reactor was 8.8 mL; an area of a light-receiving window of the outer tube receiving light from a light source was 109 cm² as a measured value in a region irradiated with a lamp; and a (light-receiving window area)/(channel volume) ratio was 1,240 m⁻¹ and reduced to about ¼ as compared with the reactor having a glass rod provided therein.

### Reaction Activity Evaluation 2

Using each of the photochemical reactors as produced above, a 1M isophorone-methanol solution was used to evaluate the photochemical reactor. The 1M isophorone-methanol solution was prepared by adding isophorone (manufactured by Wako Pure Chemical Industries, Ltd., model number: 095-01796) to methanol (manufactured by Wako Pure Chemical Industries, Ltd., model number: 136-01837). As a light source for exciting the photocatalyst, six 20 W germicidal lamps (manufactured by Toshiba Corporation, model number: GL20F) were used. The aforementioned six germicidal lamps were disposed surrounding the aforementioned glass tube in parallel to the aforementioned glass tube. Using the aforementioned germicidal lamps, light was irradiated in a region of 580 mm of the center of the outer tube of the photochemical reactor of Example 2. In the photochemical reactor of Example 2, after lighting the six germicidal lamps, the 1M isophorone-methanol solution was allowed to flow through in the channel of the photochemical reactor of Example 2 at a flow rate of 0.5 cm³/min. Under those conditions, a flow speed became 13 cm/min, a residence time of the 1M isophorone-methanol solution in the photochemical reactor of Example 2 was 4.4 minutes. In addition, in the photoreactor of Comparative Example 3, in order to make comparison at the same flow speed as in the reactor of Example 2, the flow rate was set to 2.0 cm³/min, and the 1M isophorone-methanol solution was allowed to flow through in the channel under the conditions of the same flow speed (13 cm/min) and residence time of the reactor (4.4 minutes) as in Example 2.

The 1M isophorone-methanol solution treated by the photochemical reactor was analyzed using a liquid chromatograph (column: model number Inersil CN-3, manufactured by GL Sciences Inc., development solvent: hexane/ethanol=95/5)

### Evaluation Result 2

In the photochemical reactor of Example 2, a concentration of an HT-type dimer of isophorone was 2.2 mM, a concentration of an HH-type dimer was 12.5 mM, and a conversion was about 3%. Meanwhile, in the photochemical reactor of Comparative Example 3, a concentration of an HT-type dimer of isophorone was 0.9 mM, a concentration of an HH-type dimer was 4.0 mM, and a conversion was about 1%. According to this, the conversion of the photochemical reactor of Example 2 was improved by about 3 times the conversion of the photochemical reactor of Comparative Example 3. An HH/HT ratio of the photochemical reactor of Example 2 was 5.6, whereas an HH/HT ratio of the photochemical reactor of Comparative Example 3 was 4.4, so that it was noted that the both had approximately equal selectivity.

### Production of Photochemical Reactor of Example 3

On an inner wall of the outer tube of the photochemical reactor of Example 2 (glass tube having an inner diameter of 14.5 mm), a dispersion liquid of anatase-type titanium oxide (20% ethanol solution of anatase-type titanium oxide (manufactured by JGC C&C, model number: PST18NR) was dip-coated, thereby forming a coating of anatase-type titanium oxide on the inner wall of the outer tube. The coating was baked at 450° C. for 2 hours, thereby forming an anatase-type titanium oxide layer on the inner wall of the outer tube. Subsequently, two rare-earth magnets were adhered in the interior, and then, an inner tube (glass tube having an outer diameter of 14.0 mm), both ends of which were heat-sealed, was inserted into the interior of the outer tube. Since a difference between the inner diameter of the outer tube and the outer diameter of the inner tube was 500 μm, a gap between the inner surface of the outer tube and the outer surface of the inner tube became 250 μm. A ring-shaped Teflon (registered trademark) tool was disposed outside this outer tube such that its center was approximately coincident with a central axis of the outer tube. On an inner wall of the ring-shaped Teflon (registered trademark) tool, two rare-earth magnets were disposed, respectively so as to form an N—S pair with and oppose to the magnets adhered in the interior of the inner tube. According to this, when the Teflon (registered trademark) tool was rotated utilizing a motor, the inner tube was rotated in a non-contact state.

A 1/16-inch conduit made of Teflon (registered trademark) was connected to each of a lower part and an upper part of this outer tube, and one 20 W black light lamp (manufactured by Hitachi, Ltd., model number: FL20S BL-B) was disposed on each side of the outer tube, thereby producing a photochemical reactor of Example 3. A gap between the surface of the lamp and the surface of the outer tube was set to 22 mm.

### Evaluation Result 3

A 4-chlorophenol aqueous solution (50 μM) was liquid-fed to the fluid flow-through passage between the outer tube and the inner tube at a flow speed of 1 mL/min using a syringe pump, and a concentration of 4-chlorophenol in the solution discharged from the fluid flow-through passage was measured to determine a conversion. In the case of not rotating the inner tube, the conversion was 39%. On the other hand, in the case of rotating the inner tube at a rotation speed of 8.6 rpm, the conversion was 60%. This was a value of about 1.5 times the conversion in the case of not rotating the inner tube. Furthermore, in the case of rotating the inner tube at a rotation speed of 27 rpm, the conversion was 70%, and in the case of rotating the inner tube at a rotation speed of 80 rpm, the conversion was 69%. According this, it was noted that by rotating the inner tube, the conversion can be increased, and an effect thereof is approximately saturated at a rotation number of the reactor of 27 rpm. It may be expected that this was caused due to the fact that the stirring of the solution flowing in the fluid flow-through passage was accelerated by the rotation of the inner tube.

### INDUSTRIAL APPLICABILITY

The fluid flow-through device according to the present invention can be widely utilized as a fluid flow-through device through which a thin fluid layer flows. For example, the fluid flow-through device according to the present invention can be utilized for microchannel-type reactors and photochemical reactors as markedly scaled-up, and so on. In addition, the photochemical reactor of the present invention can be utilized for fluid treatment apparatus, such as gas purification apparatus, drinking water purification apparatus, high-concentration sewage treatment apparatus, etc.

### REFERENCE SIGNS LIST

1 and 1A to 1E: Fluid flow-through device
2 and 2A to 2F: Outer tube
3 and 3A to 3F: Inner tube
4: Channel
5: Spacer
6: Light source
10F: Photochemical reactor

1. A fluid flow-through device comprising:
an outer tube having an outer surface and an inner surface; and either an inner tube having an outer surface and an inner surface, the inner tube being disposed inside the outer tube and forming a channel of a fluid by the inner surface of the outer tube and the outer surface of the inner tube, or a rod-shaped body having an outer surface, the rod-shaped body being disposed inside the outer tube and forming a channel of a fluid by the inner surface of the outer tube and the outer surface of the rod-shaped body,
with a distance between the inner surface of the outer tube and the outer surface of the inner tube or the rod-shaped body in a thickness direction of the outer tube being from 100 nm to 5 mm.

2. The fluid flow-through device according to claim 1, wherein the distance between the inner surface of the outer tube and the outer surface of the inner tube or the rod-shaped body in a thickness direction of the outer tube is from 1 μm to 1 mm.

3. The fluid flow-through passage according to claim 1 or 2, wherein the outer tube, or the inner tube or the rod-shaped body rotates in a circumferential direction, or both the outer tube and the inner tube or the rod-shaped body rotate in a circumferential direction and mutually opposite directions.

4. The fluid flow-through passage according to claim 3, wherein a rotation direction of the outer tube, or the inner tube or the rod-shaped body is periodically reversed.

5. The fluid flow-through passage according to claim 1, further comprising
a ring-shaped tool disposed outside the outer tube such that its center is coincident with a central axis of the outer tube;
a magnet fixed to the inner tube and disposed in the interior of the inner tube; a magnet disposed inside the ring-shaped tool so as to form an N—S pair with and oppose to the magnet disposed in the interior of the inner tube; and
a rotation unit that rotates the ring-shaped tool in a circumferential direction,
in which when the ring-shaped tool is rotated in the circumferential direction, the inner tube rotates in the circumferential direction.

6. The fluid flow-through device according to claim 1, wherein at least a part of the outer tube, or the inner tube or the rod-shaped body is constituted of a porous material.

7. The fluid flow-through device according to claim 6, wherein the porous material is a porous ceramic material, a porous glass material, a porous metal material, or a porous resin material.

8. The fluid flow-through device according to claim 7, wherein the porous material includes a porous resin material containing at least one selected from the group consisting of polytetrafluoroethylene, polychlorotrifluoroethylene, polyvinylidene fluoride, polyvinylidene chloride, polyvinyl chloride, Nafion (R), a polyfluoroethylene propene copolymer, a perfluoroalkoxyalkane, an ethylene/tetrafluoroethylene copolymer, a tetrafluoroethylene-perfluorodioxol copolymer, a polyetherketone, a polyimide, polybutylene naphthalate, a polyether sulfone, an aromatic polyester, a polyamide, a nylon, polyvinylpyrrolidone, a polyallylamine, polystyrene and a substitution product thereof, polyethylene, polyvinyl alcohol, polypropylene, and a polycarbonate, or a copolymer containing a part thereof.

9. The fluid flow-through device according to claim 7, wherein the porous material is a metal-made porous material, a metal fine powder sintered porous body, a metal coil filter, a porous structure in which an organic surface treating agent is applied onto the surface of such a porous metal material, a porous structure in which a polymer thin film is formed on the surface of such a porous metal material, or a porous structure in which a surface coating layer of an inorganic compound is formed on the surface of such a porous metal material.

10. The fluid flow-through device according to claim 1, wherein
a cross-sectional shape of the inner surface of the outer tube in a vertical direction to an axial direction of the outer tube is circular or elliptic; and
a cross-sectional shape of the outer surface of the inner tube in a vertical direction to an axial direction of the inner tube, or a cross-sectional shape of the rod-shaped body in a vertical direction to an axial direction thereof, is circular or elliptic.

11. The fluid flow-through device according to claim 1, wherein
a cross-sectional shape of the inner surface of the outer tube in a vertical direction to an axial direction of the outer tube is polygonal; and
a cross-sectional shape of the outer surface of the inner tube in a vertical direction to an axial direction of the inner tube, or a cross-sectional shape of the rod-shaped body in a vertical direction to an axial direction thereof, is polygonal.

12. The fluid flow-through device according to claim 1, further comprising a spacer for narrowing a width of a channel in a thickness direction of the outer tube, the spacer being disposed on at least one surface of the inner surface of the outer tube and the outer surface of the inner tube or the rod-shaped body.

13. A photochemical reactor comprising:
the fluid flow-through device according to claim 1; and
a photocatalyst disposed on at least one surface of the inner surface of the outer tube and the outer surface of the inner tube or the rod-shaped body.

14. The photochemical reactor according to claim 13, further comprising a light source radiating light that transmits through the inner tube to excite the photocatalyst, the light source being disposed inside the inner tube.

15. The photochemical reactor according to claim 13, further comprising a light source radiating light that transmits through the outer tube to excite the photocatalyst, the light source being disposed outside the outer tube.

16. The photochemical reactor according to claim 13, wherein the photocatalyst is titanium oxide.

17. The photochemical reactor according to claim 13, wherein the photocatalyst is titanium oxide containing 50% or more of brookite-type titanium oxide.

18. The photochemical reactor according to claim 13, wherein the photocatalyst is titanium oxide manufactured by the vapor deposition method.

19. A photochemical reactor comprising:
the fluid flow-through device according to claim 1; and
a light source on the outside of the outer tube, thereby enabling the outer tube to transmit light, a light source on the inside of the inner tube, thereby enabling the inner tube to transmit light, or light sources on the outside of the outer tube and on the inside of the inner tube, thereby enabling the outer tube and the inner tube to transmit light.

20. The photochemical reactor according to claim 19, wherein a material of the outer tube or a material of the inner tube or the rod-shaped body is a quartz glass.

21. (canceled)
